(19) United States
(12) Patent Application Publication
(10) Pub. No.: US 2005/0251643 A1
(43) Pub. Date: Nov. 10, 2005

(54) Memory arrangement

(75) Inventors: Gerd Dirscherl, Munich (DE); Christian Peters, Vaterstetten (DE); Holger Sedlak, Sauerlach (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/125,819

(22) Filed: May 9, 2005

Related U.S. Application Data
(63) Continuation of application No. PCT/DE03/03437, filed on Oct. 16, 2003.

(30) Foreign Application Priority Data
Nov. 8, 2002 (DE) 102 52 059.3

(51) Int. Cl. G06F 12/08

(52) U.S. Cl. 711/206

(57) ABSTRACT

A memory arrangement and method for operating the memory arrangement comprising a nonvolatile memory and at least one address translation unit, the nonvolatile memory having memory pages and at least one additional memory page, the memory pages and the additional memory page having physical addresses and the address translation unit translating logically addressable addresses into the physical addresses of the memory pages and of the additional memory page. The nonvolatile memory stores data which make address translation possible within an unaddressable area in the memory pages and in the additional memory page. For the purposes of programming a memory page, a copy of data and a copy of the data of the unaddressable area are stored in a further memory for processing and the data of the unaddressable area are changed. Once programming has been completed, the processed copy of the data and the changed data of the unaddressable area are stored in the additional memory page.

### CROSS-REFERENCE TO RELATED APPLICATION

This application is a continuation of International Patent Application Serial No. PCT/DE03/003437, filed Oct. 16, 2003, which published in German on May 21, 2004 as WO 2004/042740, and is incorporated herein by reference in its entirety.

### FIELD OF THE INVENTION

The present invention relates to a method for operating a memory arrangement.

### BACKGROUND OF THE INVENTION

During the programming of data, numerous applications such as, for example, portable data carriers, mobile data processing, wireless data and power transmission and also security-relevant devices require that the original contents of a memory cell be retained during programming in the event of the power supply failing or being disconnected.

“EEPROMs” (Electrically Erasable and Programmable Read Only Memories) or flash memories and flash EEPROMs, respectively, are currently customary electrically erasable and programmable nonvolatile semiconductor memories. Memory devices of this type have a high memory cell density and may be electrically erased or reprogrammed at any time. In this case, the memory devices are generally subdivided into a number of sectors. These sectors are in turn subdivided into a multiplicity of pages.

In EEPROMs, the data can be stored page by page in individual segments of the pages. In order to be erased, the data are marked segment by segment. A flash memory can only be programmed page by page, whereas an EEPROM has a considerably lower granularity on account of its structure. In a flash memory, data which are to be erased are marked but they are only erased page by page.

In order to program data of a flash memory, a copy of the data of one or more memory pages is loaded into a further memory. For the purposes of storing the data, the previously copied data of a memory page are erased and the programmed data are stored on the page. Voltage dips and the failure or disconnection of the power supply during programming may result in a programming or erasure operation being aborted. It is therefore possible, once an erasure operation has been carried out, that the original data are erased and that the copy of the data is no longer available in the main memory either as a result of a power failure which has occurred.

The applicant, at least, is aware of the fact that complex algorithms containing a plurality of erasure and programming cycles are used during the programming of data in order to avoid data loss and undefined data states as a result of a power failure (tearing-proof programming), twice to four times the programming time being required.

### SUMMARY OF THE INVENTION

An object of the present invention is to specify a simple and fast method for operating a memory arrangement, the method enabling “tearing-proof programming” of data of a memory device, so that it is possible, in the event of a power failure, to continue to access the original data once programming has been carried out.

In the case of the method according to the invention for operating a memory arrangement, the memory arrangement comprises a nonvolatile memory, for example a flash memory, and an address translation unit, for example a main memory, the nonvolatile memory having memory pages and at least one additional memory page which may be addressed by means of physical addresses. In the address translation unit, the physical addresses of the memory pages of the flash memory are assigned to the addresses which may be logically addressed by the processor. The logical addresses are translated into physical addresses in the address translation unit, with the result that it is possible to quickly access the memory pages. An unaddressable area of the memory pages of the flash memory on the one hand stores the logical addresses which have been assigned to the physical addresses of a memory page and, on the other hand, incorporates a counter. In order to program an addressed memory page, a copy of the data and a copy of the data of the unaddressable area are copied to a further memory for processing and the counter associated with the copy of the data is incremented by one. After programming has been completed, the processed copy of the data and the data of the unaddressable area are stored in the additional memory page.

### BRIEF DESCRIPTION OF THE DRAWINGS

The invention is explained in more detail below on the basis of an exemplary embodiment and with reference to the figures. Identical or corresponding elements in different figures are provided with identical reference symbols.

FIG. 1 shows a memory arrangement for carrying out the method according to the invention;

FIG. 2a shows an exemplary embodiment of a sector of a nonvolatile memory;

FIG. 2b shows an exemplary embodiment of an address translation unit;

FIG. 2c shows a memory page of a nonvolatile memory;

FIG. 2d shows the contents of the memory page shown in FIG. 2e in a further memory;

FIG. 2e shows a further memory page of a nonvolatile memory after programming;

FIG. 2f shows the address translation unit after programming of the memory page; and

FIG. 2g shows the memory pages of the nonvolatile memory after programming.

### DETAILED DESCRIPTION OF PREFERRED EMBODIMENTS OF THE INVENTION

In the case of the method according to the invention for operating a memory arrangement, the memory arrangement comprises a nonvolatile memory, for example a flash memory, and an address translation unit, for example a main memory, the nonvolatile memory having memory pages and at least one additional memory page which may be addressed by means of physical addresses. In the address translation unit, the physical addresses of the memory pages of the flash memory are assigned to the addresses which may be logically addressed by the processor. The logical addresses are translated into physical addresses in the address translation unit, with the result that it is possible to quickly access the memory pages. An unaddressable area of the memory pages of the flash memory on the one hand stores the logical addresses which have been assigned to the physical addresses of a memory page and, on the other hand, incorporates a counter. In order to program an addressed memory page, a copy of the data and a copy of the data of the unaddressable area are copied to a further memory for processing and the counter associated with the copy of the data is incremented by one. After programming has been completed, the processed copy of the data and the data of the unaddressable area are stored in the additional memory page.

As a result of the fact that the programmed data are stored on the additional memory page, the original data must not be erased before the programmed data have been stored. The original data on the memory page may only be erased once the programmed data have been stored. The memory page subsequently assumes the function of an additional memory page. In the address translation unit, the physical address is furthermore assigned to the additional memory page in the place of the logical address assigned to the addressed memory page.

It is particularly advantageous that, once programming has been carried out, the data are still present on the memory page and the changed data are present on the additional memory page and can be differentiated on the basis of their different counter value in the unaddressable area. The particular advantage of the method according to the invention is evident therefrom. An interruption in the power supply when programming the data has no effect on the original data, with the result that the latter can still be accessed. If, in the event of an interruption in the power supply, the data have already been stored on the additional memory page, the logical addresses of the associated physical addresses of a memory page and additional memory page (the logical addresses being stored in the unaddressable area of the memory page and in the unaddressable area of the additional memory page) are evaluated sector by sector when power supply is resumed. The previously evaluated physical addresses of the memory pages are assigned to the logical addresses of the address translation unit. If two memory pages having a different physical address and having a matching logical address are found, only that physical address of a memory page which has a higher counter reading in the unaddressable area is assigned to the corresponding logical address in the address translation unit.

A further particular advantage of the method according to the invention results from the fact that, during programming, a flash memory has the granularity of an EEPROM. As a result of the fact that the changed data are stored in the additional memory page of the nonvolatile memory, only the changed data are affected in the event of an interruption in the power supply, with the result that it is still possible to access all data of the memory page.

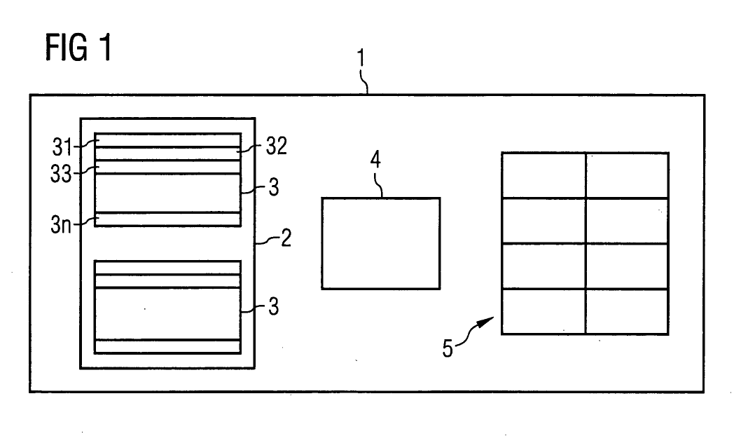

FIG. 1 shows a memory arrangement 1 for carrying out the method according to the invention. The memory arrangement 1 comprises a nonvolatile flash memory 2, a further memory 4 and an address translation unit 5. The nonvolatile flash memory 2 is subdivided into sectors 3 which, for their part, have physical memory pages 31, 32, 33 and 3n. In the address translation unit 5, a logical address of the memory pages 31, 32, 33 and 3n is assigned to each physical address of the memory pages 31, 32, 33 and 3n of the nonvolatile memory 2. The logical address addressed by a processor (not shown here) is translated into the physical address by the address translation unit 5, so that the corresponding memory page 31, 32, 33 and 3n of the nonvolatile memory 2 can be accessed quickly. The logical address of a memory page in the address translation unit 5 may in this case have a variable bit width, a certain number of bits being used for addressing purposes, while the remaining number of bits may be used for error detection or other functions which are not relevant in this case.

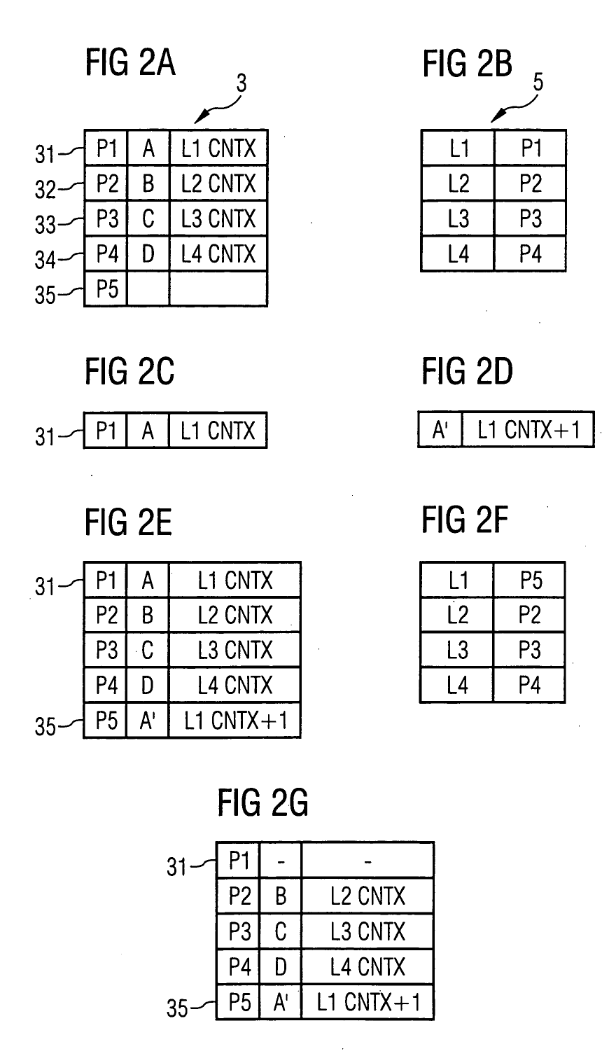

FIG. 2a shows an exemplary embodiment of a sector 3 of the nonvolatile memory 2. The sector 3 of the nonvolatile memory 2 has the memory pages 31, 32, 33, 34 and 35. In column 1, the variables P1, P2, P3, P4 and P5 represent the physical addresses of the respective memory page 31, 32, 33, 34 and 35 and, in column 2, the variables A, B, C and D represent the data stored in the memory pages 31, 32, 33 and 34. Column 3 represents an unaddressable area, which, in this exemplary embodiment, is located in the side areas of the nonvolatile memory 2. The unaddressable area is not confined to the nonvolatile memory 2 and can thus be located in any desired memory. This unaddressable area contains, for every memory page, the logical address, which has been assigned to the physical address of the memory page in the address translation unit 5, and a counter. The logical addresses are represented by the variables L1, L2, L3, L4 and L5 and the counter is represented by the variable CNTX. The memory pages 31, 32, 33 and 34 which are shown in rows 1 to 4 of the sector 3 may be addressed by the processor, while the memory page 35 in row 5 represents an additional memory page, which cannot be addressed by the processor. The additional memory page furthermore does not contain addressable data and does not contain data in the unaddressable area.

An address translation unit 5, which serves to translate the logical addresses into the physical addresses of the memory pages of the nonvolatile memory 2, is shown in FIG. 2b. In each row, the physical addresses P1, P2, P3, P4 and P5 (shown in column 2) of the memory pages of the nonvolatile memory 2 are assigned to the logically addressable addresses L1, L2, L3, L4 and L5 shown in the first column.

The manner in which the data of the memory pages of the nonvolatile memory 2 are advantageously programmed is explained with reference to FIGS. 2c to 2f.

FIG. 2c shows the first memory page of the nonvolatile memory 2, as shown in FIG. 2a, row 1. For the purposes of programming, the data A in column 2 and the logical address and also the counter of the unaddressable area are copied to a further memory 4, the counter being incremented by one and changed data A′ being present in the further memory 4, as is shown in FIG. 2d. Following successful programming, the changed data A′ are stored in an additional memory page of the nonvolatile memory 2, with the result that both the original data A and the changed data A′ are available in the nonvolatile memory.

As shown in FIG. 2e, the original data A are still located in the memory page 31 in the second column of the first row. The changed data A′ are available in the additional memory page 35 in the second column of the fifth row. As a result of the fact that the data of the unaddressable area were likewise copied for the purposes of programming, the two memory pages 31 and 35 of the nonvolatile memory 2 have a matching logical address L1 in the third column. They differ, however, in the magnitude of the count of the counter CNTX and CNTX+1 in the third column.

An interruption in the power supply results in the assignments of the logical addresses L1, L2, L3 and L4 to the physical addresses P1, P2, P3, P4 and P5 of the memory pages 31, 32, 33, 34 and 35 being reconstructed in the address translation unit 5. To this end, the logical address L1, L2, L3 and L4 in the unaddressable area and also the physical address P1, P2, P3, P4 and P5 of the respective memory page 31, 32, 33, 34 and 35 are evaluated and the physical address P1, P2, P3, P4 and P5 is assigned to the respective logical address L1, L2, L3 and L4 in the address translation unit 5. In the event that two memory pages and thus two physical addresses have a matching logical address, the counts of the counters of the two memory pages are compared and that physical address of the memory page which has the higher counter count is assigned to the logical address in the address translation unit 5.

FIG. 2f shows the assignment of the addresses in the address translation unit 5 once programming has been carried out. Since the changed data A′ were stored in the additional memory page 35, as is shown in FIG. 2e, the new physical address P5 of the additional memory page 35 of the nonvolatile memory 2 has been accepted into the second column of the first row of the address translation unit 5, with the result that, when the logical address L1 is addressed, the address translation unit 5 translates the latter into the physical address P5 and the data A′ can be read from the additional memory page 35.

As shown in the first row of FIG. 2g, the data of the memory page 31 have been rendered invalid following programming, with the result that this memory page 31 is used as an additional memory page for a subsequent programming operation.

1. A method for operating a memory arrangement having a nonvolatile memory and at least one address translation unit, the nonvolatile memory having memory pages and at least one additional memory page, the memory pages and the additional memory page having physical addresses and logically addressable addresses translated into the physical addresses in the address translation unit, the method comprising the steps of:
storing data which make address translation possible within an unaddressable area in the memory pages and in the additional memory page in the nonvolatile memory;
for the purposes of programming a memory page, storing a copy of data and a copy of the data of the unaddressable area of the memory page in a further memory, and processing the memory page in the further memory by changing the data in the unaddressable area; and
once programming has been completed, storing the processed copy of the data and the changed data of the unaddressable area in the additional memory page.

2. The method as claimed in claim 1, wherein the data in the unaddressable areas of the memory pages and of the additional memory page of the nonvolatile memory correspond to the logical addresses assigned to the physical addresses of the memory pages and of the additional memory page and have respective counters.

3. The method as claimed in claim 1, further comprising the step of changing the data of the unaddressable area during the programming of the memory page by incrementing the respective counter by one.

4. The method as claimed in claim 1, further comprising a programming step comprising the steps of:
(a) storing the data in the addressed memory page and storing the processed copy of the data in the additional memory page, the memory page and the additional memory page having a matching logical address in an unaddressable area, and the memory page and the additional memory page having different counter readings in an unaddressable area;
(b) invalidating the data and also the data of the unaddressable area of the addressed memory page; and
(c) assigning the physical address to the additional memory page in the place of the logical address, which has been assigned to the addressed memory page, in the address translation unit.

5. The method as claimed in claim 4, wherein the addressed memory page becomes the additional memory page after programming has been carried out.

6. The method as claimed in claim 1, wherein the nonvolatile memory is a flash memory.

7. The method as claimed in claim 1, wherein the address translation unit is a main memory.

8. The method as claimed in claim 1, further comprising the steps of:
dividing the nonvolatile memory into sectors, wherein the nonvolatile memory has a fixed number of physical memory pages;
following an interruption in a power supply, evaluating sector by sector the logical addresses of the associated physical addresses of the memory page and additional memory page;
assigning the previously evaluated physical addresses of the memory pages and additional memory page to the logical addresses of the address translation unit; and
if there are two memory pages and an additional memory page, respectively, having a matching logical address, assigning to the corresponding logical address in the address translation unit, only that physical address of the memory page or additional memory page which has a higher reading of the counter in the unaddressable area.

9. A memory arrangement comprising:
at least one address translation unit;
a nonvolatile memory having memory pages and at least one additional memory page, the memory pages and the additional memory page having physical addresses and logically addressable addresses translated into the physical addresses in the address translation unit;
means for storing data which make address translation possible within an unaddressable area in the memory pages and in the additional memory page in the nonvolatile memory;
means for storing a copy of data and a copy of the data of the unaddressable area of the memory page in a further memory, and for processing the memory page in the further memory by changing the data in the unaddressable area; and
means for storing the processed copy of the data and the changed data of the unaddressable area in the additional memory page.

10. The memory arrangement as claimed in claim 9, wherein the data in the unaddressable areas of the memory pages and of the additional memory page of the nonvolatile memory correspond to the logical addresses assigned to the physical addresses of the memory pages and of the additional memory page and have respective counters.

11. The memory arrangement as claimed in claim 9, further comprising a means for changing the data of the unaddressable area by incrementing the respective counter by one.

12. The memory arrangement as claimed in claim 9, further comprising means for programming comprising:
means for storing the data in the addressed memory page and for storing the processed copy of the data in the additional memory page, the memory page and the additional memory page having a matching logical address in an unaddressable area, and the memory page and the additional memory page having a different counter readings in an unaddressable area;
means for invalidating the data and also the data of the unaddressable area of the addressed memory page; and
means for assigning the physical address to the additional memory page in the place of the logical address, which has been assigned to the addressed memory page, in the address translation unit.

13. The memory arrangement as claimed in claim 12, wherein the addressed memory page becomes the additional memory page after programming has been carried out.

14. The memory arrangement as claimed in claim 9, wherein the nonvolatile memory is a flash memory.

15. The memory arrangement as claimed in claim 9, wherein the address translation unit is a main memory.

16. The memory arrangement as claimed in claim 9, further comprising:
means for dividing the nonvolatile memory into sectors, wherein the nonvolatile memory has a fixed number of physical memory pages;
means for following an interruption in a power supply, evaluating sector by sector the logical addresses of the associated physical addresses of the memory page and additional memory page;
means for assigning the previously evaluated physical addresses of the memory pages and additional memory page to the logical addresses of the address translation unit; and
means for assigning, if there are two memory pages and an additional memory page, respectively, having a matching logical address, to the corresponding logical address in the address translation unit, only that physical address of the memory page or additional memory page which has a higher reading of the counter in the unaddressable area.
